(19) United States
(12) Patent Application Publication
(10) Pub. No.: US 2007/0137509 A1
(43) Pub. Date: Jun. 21, 2007

(54) Electrowetting printer

(75) Inventor: David K. Fork, Los Altos, CA (US)

Correspondence Address: Mark S. Svat;FAY, SHARPE, FAGAN, MINNICH & McKEE, LLP, SEVENTH FLOOR, 1100 SUPERIOR AVENUE, CLEVELAND, OH, 44114-2579, US

(73) Assignee: PALO ALTO RESEARCH CENTER INCORPORATED

(21) Appl. No.: 11/311,780

(22) Filed: Dec. 19, 2005

(51) Int. Cl. B41C 1/10; B41N 3/00

(52) U.S. Cl. 101/465; 101/467

(57) ABSTRACT

A print system includes a print structure with a surface. The print system further includes an electrolyte bath in which the surface of the print structure passes through while being exposed by an expose component that forms an image of charge on the surface. An electrolyte from the electrolyte bath adheres to the charge on the surface. The print system further includes an ink bath that applies ink to unexposed portions of the surface to form an inked image on the surface.

### BACKGROUND

The following relates to printing. It finds particular application to print surfaces. More particularly, it is directed to addressing a print surface based on the electrowetting effect.

Offset printing is a printing technique in which an inked image is transferred to a rubber blanket (e.g., an offset drum) and then to a printing surface. Conventional offset printing typically employs a print drum surface that is divided into hydrophilic and hydrophobic regions. The drum is decorated with islands of water and ink that is subsequently transferred to an offset drum. The ink on the offset set drum is then transferred to a printed page. When used in combination with a lithographic process based on the repulsion of oil and water, the offset technique typically employs a flat (planographic) image carrier on which the image to be printed obtains ink from ink rollers, while the non-printing areas attract a film of water, keeping the nonprinting areas ink-free. In other instances, the ink can be applied with a blade or squeegee, as is practiced in the gravure printing process.

Electrowetting technology has been used to produce an offset printer capable of variable data printing. Variable data printing is a form of on-demand printing in which elements such as text, graphics and images may be changed from one printed piece to the next without stopping or slowing down the press. Thus, variable data printing enables the mass-customization of documents. For example, a set of personalized letters can be printed with a different name and address on each letter, as opposed to merely printing the same letter a plurality of times. The technique is an outgrowth of digital printing, which harnesses computer databases and digital presses to create full color documents. Electrowetting is the ability to modify the spreading of a liquid on a surface by the application of electrostatic charge. Typically, an insulating layer is included on the electrowetting electrode.

Conventional techniques for writing the electrostatic image typically employ a proximity electrode. As a result, the electric field drops across an air gap between the electrode and the insulator. Thus, there is an unresolved need for improved print structure that reduces the electric field drop off.

### BRIEF DESCRIPTION

In one aspect, a print system is illustrated. The print system includes a print structure with a surface. The print system further includes an electrolyte bath in which the surface of the print structure passes through while being exposed by an expose component that forms an image of charge on the surface. An electrolyte from the electrolyte bath adheres to the charge on the surface. The print system further includes an ink bath that applies ink to unexposed portions of the surface to form an inked image on the surface.

### BRIEF DESCRIPTION OF THE DRAWINGS

FIG. 1 illustrates a portion of a print system, which forms an image on a print surface by exposing the print surface through an electrolyte bath;

FIG. 2 illustrates a portion of the various layers of the print surface of the print system;

FIG. 3 illustrates a portion of the print system with an intermediate transfer medium;

FIG. 4 illustrates a method for addressing the print surface by exposing the print surface through the electrolyte bath;

FIG. 5 illustrates a non-limiting example showing an electrolyte contact angle with no bias;

FIG. 6 illustrates a non-limiting example showing an electrolyte contact angle with a three hundred volt bias; and

FIG. 7 illustrates a non-limiting example showing an electrolyte contact angle with a thousand volt bias.

### DETAILED DESCRIPTION

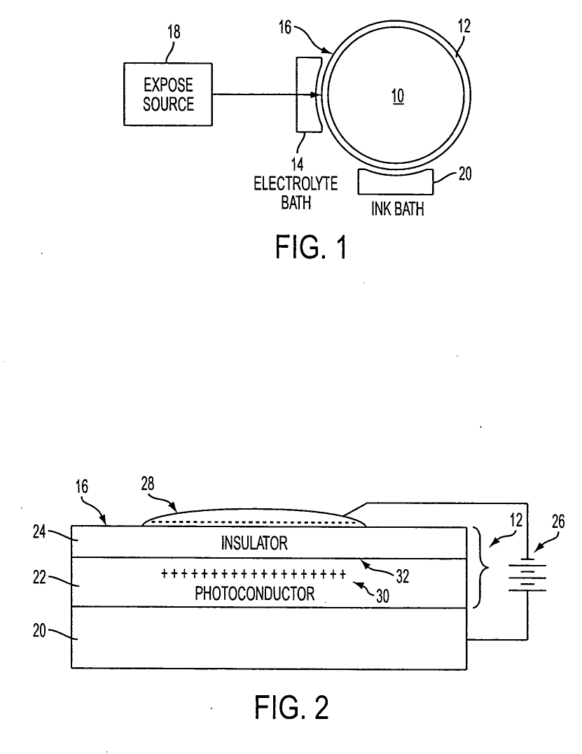

With reference to FIG. 1, a portion of a print system is illustrated. The portion of the print system includes a print structure 10 (e.g., a drum, a belt, a transfer medium, etc.) with one or more layers 12 that facilitate attracting materials such as electrolytes, ink, etc. to a surface 16. The portion of the print system further includes an electrolyte bath 14 that is positioned adjacent to the surface 16 of the structure 10. The electrolyte bath 14 houses an aqueous electrolyte, water, and/or other materials. In one instance, the electrolyte bath 14 is held at an electrical potential suitable to drive an electrowetting process and the structure 10 is held at an electrical ground potential.

The one or more layers 12 are variously exposed by an expose source 18 through the electrolyte bath 14. The exposure creates hydrophobic regions on the surface 16, which correspond to non-exposed regions, and hydrophilic regions on the surface 16, which correspond to exposed regions. The exposure creates a latent electrostatic image on the surface 16, and the electrolyte in the electrolyte bath 14 adheres to charged portions of the surface 16. Upon exiting the electrolyte bath 14, the aqueous electrolyte, and/or other material remains on the hydrophilic regions of the surface 16, or exposed areas. The partially wetted surface 16 then passes through an ink bath 20, which houses ink and/or other materials. The ink and/or other materials in the ink bath 20 wets the hydrophobic regions of the surface 16, or unexposed areas that not wetted with the electrolyte. This results in an inked image on the surface 16 that can be transferred to another surface.

FIG. 2 illustrates a portion of the print structure 10, the one or more layers 12, and the surface 16. As depicted, the one or more layers 12 can include a photoconductor layer 22 and an insulator layer 24. Typically, the photoconductor layer 22 is formed over the structure 10, and the insulator layer 24 is formed over the photoconductor layer 22. An electrical potential 26 can be applied across an electrolyte drop 28 on the surface 16 and the structure 10, which behaves as an electrode. The electrical potential 26 applied across the electrolyte drop 28 can be a potential suitable for electrowetting. As discussed in detail below, the electrical potential, among other parameters, controls a contact angle of the electrolyte drop 28 with the surface 16.

In areas where the photoconductor 22 is irradiated (e.g., with light or other suitable energy) by the expose source 18, the photoconductor 22 conducts charge 30 that accumulates against an insulator-photoconductor interface 32. The charge 30 attracts the electrolyte drop 28 and modifies the surface wetting characteristics. Exposing the photoconductor layer 22 image-wise results in the image-wise wetting of the surface 16. Ink can then be applied to the partially wetted surface 16 through the ink bath 20 as described above to create an inked image, which can be transferred to another surface.

In some instance, the photoconductor layer 22 and/or insulator layer 24 can be formed from a single layer, whereas in other instance either or both layers 20 and 24 can be formed from multiple layers. For example, the insulator layer 24 can include one layer that defines the characteristics of the wetting surface 16 and a different layer that increases breakdown strength.

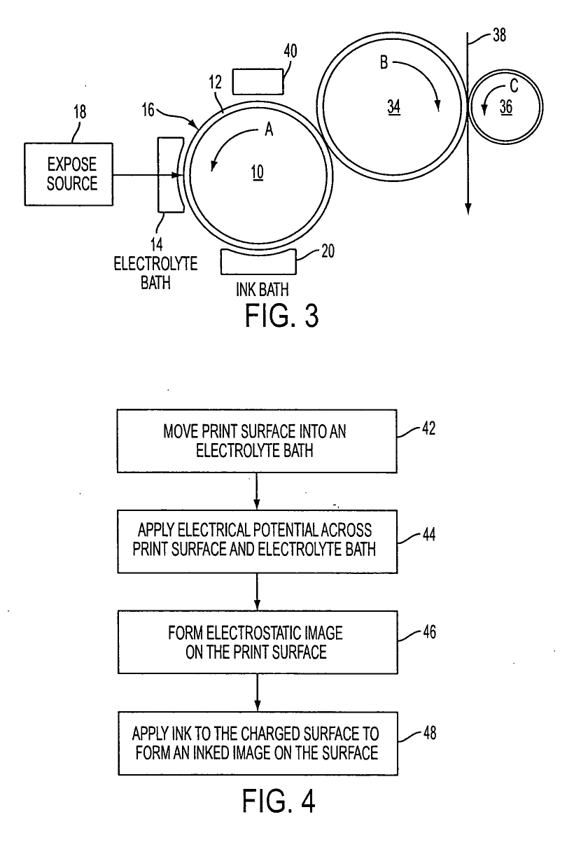

FIG. 3 illustrates the print system with an intermediate transfer mechanism. The print system includes the structure 10 (with the photoconductor layer 22 and the insulator layer 24), the electrolyte bath 14 and the ink bath 20, and further includes a second structure 34 and a third structure 36. As depicted, each of the structures 10, 34 and 36 rotate in a direction corresponding to A, B, and C. As described above, the structure 10 moves (e.g., rotates) such that the surface 16 passes through the electrolyte bath 14, which is held at an electrical potential suitable to drive an electrowetting process.

One or more portions of the surface 16 are exposed through the electrolyte bath 14 of aqueous electrolyte and/or other material. The device 18 used to expose the one or more portions of the surface 16 can be any exposing device such as a laser, a light emitting diode (LED) spot, etc. Alternatively, a master document can be imaged onto the surface 16 using a technique similar to imaging in light-lens xerographic copiers. Charge forms on the exposed areas and accumulates against the interface between the insulator layer 24 and the photoconductor layer 22. The charge attracts the electrolyte in the bath 14 and modifies the surface wetting characteristics. An image-wise exposure results in an image-wise wetting of the surface 16. In an alternative embodiment, rather than using the photoconductor layer 22 to switch the voltage applied to the electrowetting surface, an active matrix backplane can be used to produce a variable data-wetting surface for printing.

The partially wetted structure 10 passes out of the electrolyte bath 14 and through the ink bath 20. Areas on the surface 16 that are not wetted with the electrolyte are wetted by the ink and/or other material in the ink bath, creating an inked image on the surface 16. The inked image can be transferred to the second structure 34, which can be an offset drum (e.g., a rubber drum), a belt, and/or other intermediate transfer element. The ink from the structure 10 adheres to the second structure 34. The second structure 34 operatively contacts a print medium 38 (e.g., paper, velum, plastic, ceramic, etc.) that is guided by the second and the third structures 34 and 36. As the print medium 38 traverses the second structure 34, the inked image is transferred from the second structure 34 to the print medium 38.

In an alternative embodiment, the electrolyte bath 14 may include an ink as an electrolyte and an ink pattern can be directly formed on the surface 16 from the electrostaticly charged image. In this embodiment, the ink bath 20 may or may not be included in the print system. In another alternative embodiment, the structure 10 can pass through an emulsion consisting of finely divided droplets of ink and water, wherein the two materials separate onto their respective portions of the surface 10, depending on the local surface wetting. With either alternative, the inked image can then be transferred to another transfer medium such as the second structure 34, a drum, a belt, an intermediate transfer medium, another surface, etc.

After the ink is transferred from the structure 10 to the second structure 34, the surface 16 optionally passes through a cleaning component 40. The cleaning component 40 removes any ink, electrolyte, and/or other material that remains on the surface 16. In one instance, the electrolyte can be shed from the hydrophobic regions of the structure 10 with an air knife that blows materials of the structure 10. In another instance, a roller with a hydrophilic surface can be used with a wetting surface that is disposed between the hydrophobic surface and hydrophilic portions of the structure 10. It is to be appreciated that in some instances, the latent electrostatic image may be retained for multiple revolutions of the structure 10, allowing the image to be written more than one time for a single imaging operation.

FIG. 4 illustrates a method for addressing the print surface by exposing the print surface through the electrolyte bath. At 42, a print surface is enters an electrolyte bath. The print surface can be formed on a structure such as print drum, a belt, or the like. In one instance, the print surface is formed from a photoconductor and an insulator. For instance, the photoconductor can be formed over the structure and the insulator can be formed over the photoconductor. At 44, an electrical potential can be applied across an electrolyte in the bath and the print structure. Typically, the print structure is held at ground potential and the electrolyte is held at a suitable electrical potential for electrowetting.

At 46, a latent electrostatic image is formed on the surface of the structure. In one instance, the image is created by exposing one or more portions of the print surface to suitable energy. The device used to expose the one or more portions of the surface can be any exposing device such as a laser, a LED spot, etc. As a result, electrical charge is formed at the exposed portions. The charge accumulates against an insulator-photoconductor interface and attracts the electrolyte. At 48, ink is applied to the surface and adheres to the unexposed portions of the surface. For instance, upon exiting the electrolyte bath, the aqueous electrolyte remains on discharge portions of the surface. The surface then passes through an ink bath, wherein ink wets the charged portions on the surface.

Optionally, the ink can be transferred to another surface. For example, the inked surface can operatively contact a drum, a belt, a print medium, an intermediate transfer mechanism, etc., wherein the ink is transferred to the other surface. In addition, the surface can be cleaned in order to remove ink, electrolyte, and/or other material that remains on the surface after the image is transferred. For example, the electrolyte can be removed with an air knife that blows materials of the surface. In another instance, a roller with a hydrophilic surface can be used with a wetting surface that is disposed between the hydrophobic surface and hydrophilic portions of the structure. In other instance, the latent electrostatic image may be retained from multiple transfers of the image from the surface, allowing the image to be written more than one time for a single imaging operation.

Although the above method is described as a series of acts, it is to be understood that in alternative instances one or more of the acts can occur in a different order, one or more of the acts can concurrently occur with one or more other acts, and more or less acts can be used.

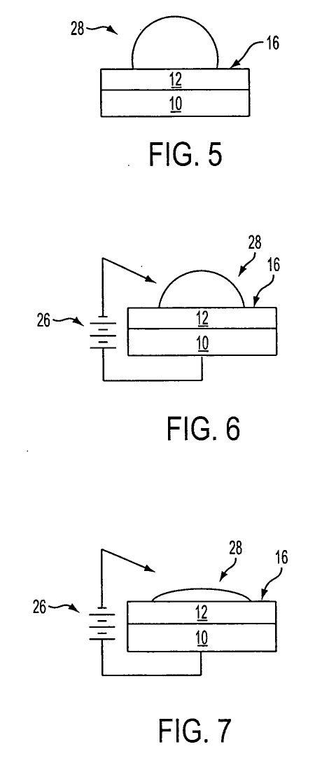

FIGS. 5-7 illustrates a non-limiting example that demonstrates the control of a contact angle 58 of the electrolyte drop 28 with the surface 16 by adjusting the electrical potential 26. These figures show that the contact angle 58 increases with the applied bias from no bias (FIG. 5) through about three hundred volts (FIG. 6) to about one thousand volts (FIG. 7). Fields of between 10 and 40 V/μm were used to change the contact angle 58 from about 110 to about 45 degrees. The results were qualitatively substantially similar for 0.1M NaCl solution and for pure DI water. Other suitable materials include, but are not limited to, VHB and Teflon. The relationship between a contact angle and the electrical potential 22 is a function of the following:

$$cos ( θ ) = cos ( {θ}_{0} ) + \frac{c}{2 γ} {V}^{2} ,$$

wherein θ is the contact angle, θ₀ is an initial contact angle, c is a capacitance per unit area of the insulating dielectric, γ is a surface tension of the electrolyte, and V is the applied electrical potential. The capacitance c can be altered by layering the insulator layer 24 together with the photoconductor layer 22.

FIG. 2 above illustrated an electrolyte drop 28 on a portion of the surface 16 in which a corresponding portion of the photoconductor 22 has been locally charged. The charge is applied by holding the structure 10 at electrical ground potential and the holding the electrolyte drop at a suitable electrowetting potential. The charge accumulates at the interface between the photoconductor 22 and the insulator 24 and attracts the electrolyte drop 28 to the surface 16. Tables 1 and 2 below illustrate various inputs (Table 1) and outputs (Table 2) parameters associated with an exemplary scenario.

TABLE 1
Exemplary input parameters

| Inputs | | | |
|---|---|---|---|
| Surface tension of water | γLV | 73 | mN/m |
| Insulator surface energy | γSV | 15.65 | mN/m |
| Insulator thickness | D | 25 | μm |
| Insulator dielectric constant | ε | 1.91 | |
| Insulator breakdown field | Eimax | 20.6 | V/μm |
| Photoconductor dielectric | εp | 2.9 | |
| Photoconductor thickness | dp | 50 | μm |
| Permativity of free space | εo | 8.85E−12 | F/m |
| Unbiased contact angle | θo | 105 | degrees |

| | | |
|---|---|---|
| Applied bias | V | 450 |

TABLE 2
Exemplary output parameters

| Outputs | | | |
|---|---|---|---|
| Switching range | Vs | 657.0 | Volts |
| On-state capacitance | Cono | 67.6 | pF/cm2 |
| On-state wetting angle | θon | 47.2 | degrees |
| On-state field | Eon | 18.0 | V/μm |
| Off-state capacitance | Coff | 29.2 | pF/cm2 |
| Off-state wetting angle | θoff | 81.6 | degrees |
| Photoconductor field | Ep | 3.6 | v/μm |

The system and methods described herein facilitates offset printing with variable data. This allows the use of more favorable inks that those that can be employed for ink jet printing. In particular, non-aqueous and highly viscous inks can be printed with variable data. Viscous ink, by virtue of its high pigment content, can provide highly saturated colors. The system and methods described herein can be used to print viscous including inks containing metals, semiconductors, ceramics, etc. on various surfaces

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A print system, comprising:
a print structure having a surface;
an electrolyte bath in which the surface of the print structure passes through;
an exposed component that forms an image of charge on the surface as the surface passes through the electrolyte bath and an electrolyte within the electrolyte bath adheres to the charge; and
an ink bath that applies ink to unexposed portions of the surface to form an inked image on the surface.

2. The print system as set forth in claim 1, wherein the surface is formed from a photoconductor layer residing adjacent to the print structure and an insulator layer formed over the photoconductor layer.

3. The print system as set forth in claim 2, wherein at least one of photoconductor layer and the insulator layer is formed from one or more layers.

4. The print system as set forth in claim 2, wherein the insulator layer includes at least one layer that defines one or more characteristics of a wetting surface and at least one different layer that increases breakdown strength.

5. The print system as set forth in claim 1, wherein the print structure is held at ground and the electrolyte adhering to the surface is held at an electrical potential that facilitates electrowetting.

6. The print system as set forth in claim 5, wherein the electrolyte adheres to the surface with a contact angle proportional to the square of the electrical potential.

7. The print system as set forth in claim 1, wherein the electrolyte includes at least one of water, an ink, an electrolyte, and an emulsion of ink and water.

8. The print system as set forth in claim 1, the expose component includes at least one of a laser and a light emitting diode (LED) that forms the image on the surface.

9. The printing system as set forth in claim 1, wherein the image on the surface is retained for multiple revolutions, allowing the image to be written more than one time for a single imaging operation.

10. The print system as set forth in claim 1, wherein the print structure is one of a drum, an offset drum, and a belt.

11. The printing system as set forth in claim 1, further including a second structure in which the inked image is transferred from the surface of the print structure to a surface of the second structure.

12. The print system as set forth in claim 11, wherein the second structure is one of a drum, an offset drum, and a belt.

13. The print system as set forth in claim 11, wherein the inked image is transferred from the second structure to a print medium.

14. The print system as set forth in claim 13, wherein the print medium is paper.

15. In a non-manual print system including a print structure having a surface, an electrolyte bath with an electrolyte and configured to have the surface of the print structure pass through, an exposed component of the surface, and an ink bath, a method for printing comprising:
exposing the print surface of the print structure of the print system to create an electrostatic image with one or more hydrophobic portions and one or more hydrophilic portions;
applying an electrical potential that attracts an electrolyte in the electrolyte bath to the hydrophilic portions of the print surface; and
forming the inked image on the print surface by passing the wetted print surface through the ink bath in which ink from the ink bath adheres to the hydrophobic portions of the print surface.

16. The method as set forth in claim 15, wherein the electrostatic image is formed on the print surface prior to passing the print surface through the electrolyte bath.

17. The method as set forth in claim 15, wherein the electrostatic image is formed on the print surface as the print surface passes through the electrolyte bath.

18. The method as set forth in claim 15, further including forming the print surface by forming an insulator over a photoconductor formed over an electrode.

19. The method as set forth in claim 15, further including transferring the inked image to at least one of a drum, an offset drum, a belt, and a print medium.

20. A print system, comprising:
a print structure including:
a drum,
a photoconductor layer formed adjacent to the drum, and
an insulator layer formed adjacent to the photoconductor layer, the insulator layer having a surface opposite the photoconductor layer;
an electrolyte bath;
an expose device that exposes an electrostatic image on the surface as the surface passes through the electrolyte bath and an electrolyte within the electrolyte bath adheres to the electrostatic image; and
an ink bath that applies ink to unexposed portions of the surface to form an inked image on the surface.
